(19) United States
(12) Patent Application Publication
(10) Pub. No.: US 2025/0211007 A1
(43) Pub. Date: Jun. 26, 2025

(54) EARPHONE CHARGING CASE

(71) Applicant: Goertek Technology Co., Ltd., Qingdao, Shandong (CN)

(72) Inventors: FAJIE Zhao, Shandong (CN); Changhong Zhao, Shandong (CN); Zhiwei HU, Shandong (CN)

(73) Assignee: Goertek Technology Co., Ltd., Qingdao, Shandong (CN)

(21) Appl. No.: 18/851,216

(22) PCT Filed: Jun. 29, 2022
(86) PCT No.: PCT/CN2022/102547

§ 371 Date: Sep. 26, 2024

(30) Foreign Application Priority Data
Mar. 31, 2022 (CN) 202210337118.8

(51) Int. Cl. H02J 7/00

(52) U.S. Cl. CPC H02J 7/0044

(57) ABSTRACT

The present disclosure provides an earphone charging case, which comprises a case body, a storage compartment, a lid body, and a transmission mechanism. The case body is provided with an accommodating cavity that has an opening at its upper end; the storage compartment is installed in the accommodating cavity in a manner configured to revolve up and down so as to have an upward exposure movement stroke in which the storage compartment swings toward the opening and a storing movement stroke in which the storage compartment goes down to move within the accommodating cavity; the lid body has an opening movement stroke for opening the opening and a closing movement stroke for closing the opening; and the transmission mechanism is in transmission connection with both the storage compartment and the lid body.

### CROSS-REFERENCE TO RELATED APPLICATIONS

The present disclosure is a National Stage of International Application No. PCT/CN2022/102547 filed on Jun. 29, 2022, which claims priority to a Chinese patent application No. 202210337118.8 filed with the CNIPA on Mar. 31, 2022 and entitled “EARPHONE CHARGING CASE”, both of which are hereby incorporated by reference in their entireties.

### TECHNICAL FIELD

The present disclosure relates to the field of earphones, and particularly to an earphone charging case.

### BACKGROUND

With recent development of TWS wireless earphones, although there are various forms of headphones emerging, the way of taking earphones out from earphone charging cases is relatively monotonous and generally involves flipping or sliding of the lid, which influences user experience and lacks innovative usage forms.

### SUMMARY

The main purpose of the present disclosure is to propose an earphone charging case, which aims to solve the problem that the way of using the existing earphone charging cases is relatively monotonous and lacks innovation.

To achieve the above purpose, the present disclosure proposes an earphone charging case, which comprises:
a case body provided with an accommodating cavity that has an opening at its upper end;
a storage compartment that is installed in the accommodating cavity in a manner capable of revolving up and down so as to have an upward exposure movement stroke in which the storage compartment swings toward the opening and a storing movement stroke in which the storage compartment goes down to move within the accommodating cavity;
a lid body that is movably provided at an open end of the case body and has an opening movement stroke for opening the opening and a closing movement stroke for closing the opening; and
a transmission mechanism that is provided inside the case body and is in transmission connection with both the storage compartment and the lid body so as to correspondingly convert the opening movement stroke of the lid body into the exposure movement stroke of the storage compartment, and the closing movement stroke of the lid body into the storing movement stroke of the storage compartment.

Optionally, the lid body is slidably provided at the open end of the case body along a lateral direction;
the transmission mechanism transforms a transverse movement of the lid body into revolution of the storage compartment.

Optionally, the storage compartment has a rotating part provided along a longitudinal direction such that the storage compartment revolves around the longitudinal direction;
the transmission mechanism comprises:
a driving rod that is slidably provided along the lateral direction, one end of which is in driving connection with the lid body to be driven by the lid body to slide along the lateral direction, the driving rod being provided with a plurality of teeth extending along the lateral direction;
a drive gear that is engaged with the plurality of teeth of the driving rod to be driven by the driving rod to rotate, the drive gear being in driving connection with the rotating part of the storage compartment to drive the rotating part of the storage compartment to rotate.

Optionally, the transmission mechanism further comprises a transmission gear train, which comprises:
a first transmission gear that is provided coaxially with the drive gear; and
a second transmission gear that is connected to the rotating part of the storage compartment, and is engaged with the first transmission gear.

Optionally, two storage compartments are provided;
the driving rod is provided between the two storage compartments, one mounting bracket extends obliquely toward the driving rod from a side of each of the storage compartments, the rotating part of each of the storage compartments is mounted on a corresponding mounting bracket, and an axis of the rotating part is inclined with respect to an axis of the drive gear;
the first transmission gear and the second transmission gear are provided as bevel gears to transform rotation of the drive gear into rotation of the rotating part.

Optionally, the lid body is provided with a driving part;
a driving arm, which extends up and down and is slidably provided in the lateral direction, is further provided between the driving rod and the lid body, a lower end of the driving arm is connected to one end of the driving rod, and an upper end of the driving arm extends to the lid body to be driven by the driving part and to bring the driving rod to move along the lateral direction together.

Optionally, the driving part comprises a first driving block and a second driving block that are provided on the lid body and are provided oppositely to each other along the lateral direction, the first driving block is located behind the second driving block in a direction of the lid body for slidably opening a lid, the first driving block protrudes from the second driving block in the longitudinal direction, and a driving groove is formed between the first driving block and the second driving block where the two face each other;
the accommodating cavity is provided with an inwardly extending part above the driving rod, and the inwardly extending part is provided with a driving guide-slot, which has an inclined section that is inclined with respect to the lateral direction and a lateral section that extends along the lateral direction;
a lower end of the driving arm is floatingly connected to the driving rod in the longitudinal direction, and an upper end of the driving arm extends out from the driving guide-slot;
wherein, during the opening movement stroke of the lid body, the upper end of the driving arm is driven by the first driving block, such that the upper end of the driving arm floats longitudinally into the driving groove; during the closing movement stroke of the lid body, the driving arm is driven by the inclined section of the driving guide-slot to slide longitudinally out of the driving groove.

Optionally, the lower end of the driving arm is rotationally installed on the driving rod along a transverse axis, such that the lower end of the driving arm is floatingly connected to the driving rod in the longitudinal direction.

Optionally, a side of the first driving block facing the second driving block is inclined to guide the upper end of the driving arm into the driving groove.

Optionally, the lid body is provided with a guiding groove extending along the lateral direction, and in a direction of the opening movement stroke of the lid body, the guiding groove is located at a rear end of the driving groove, and one end of the guiding groove extends to the driving groove.

Optionally, the driving rod is provided with an elastic clamper on a side thereof;
the driving rod, on a side corresponding to the elastic clamper, is provided with two restraining grooves arranged at intervals along the lateral direction so that the elastic clamper clamps with one of the two restraining grooves in the opening movement stroke, and the elastic clamper clamps with the other restraining groove in the closing movement stroke.

Optionally, a free end of the elastic clamper is formed with an inclined tooth, which comprises two inclined guiding surfaces arranged at an angle to each other;
each restraining groove is provided with two opposite sidewalls, which are arranged at an angle to each other and respectively abut against the two inclined guiding surfaces so that when the driving rod slides, the inclined tooth slides along one of the two sidewalls.

Optionally, the inwardly extending part is formed with two posts spaced in the longitudinal direction, between which the driving rod is provided;
the elastic clamper comprises two sliding sleeves that are respectively sleeved with the two posts, and a connecting part for connecting the two sliding sleeves, the inclined tooth being formed on the connecting part;
each of the two sliding sleeves and the inwardly extending part are provided with a spring therebetween, which is connected to a corresponding sliding sleeve at one end and is connected to the inwardly extending part at the other end.

Optionally, the earphone charging case further comprises an installation board that is slidably installed at the open end of the case body, and the lid body covers an upper end of the installation board;
the installation board is formed with a sliding groove extending in the lateral direction, which is provided corresponding to the driving groove and an escape groove.

In the technical solution of the present disclosure, the lid body may open and close the opening of the case body in the movement stroke, and since the transmission mechanism is in transmission connection with the storage compartment and the lid body, the transmission mechanism converts the opening movement stroke and the closing movement stroke of the lid body correspondingly into the exposure movement stroke and the storing movement stroke of the storage compartment. The storage compartment may be installed in the accommodating cavity of the case body in a manner capable of revolving up and down, and when opening the lid body, the storage compartment swings toward the opening, and while the storage compartment is raised to be exposed, it is inclined at a certain angle towards the user, which gradually elevates the earphone placed inside the storage compartment and presents it to the user, thereby presenting the earphone with a better sense of ceremony and increasing the user's experience so as to solve the problem that the way of using existing earphone charging cases is relatively monotonous and lacks innovation.

### BRIEF DESCRIPTION OF THE DRAWINGS

In order to illustrate the technical solution of the present disclosure more clearly, the accompanying drawings that need to be used in the embodiments will be briefly described below. It should be understood that the following drawings show only some embodiments of the present disclosure and should not be regarded as limiting the scope. For those skilled in the art, other relevant drawings can also be obtained based on these drawings without creative labor.

FIG. 1 shows an exploded schematic view of an embodiment of an earphone charging case provided by the present disclosure;

FIG. 2 shows a plan view of FIG. 1;

FIG. 3 shows a three-dimensional schematic view of the case body of FIG. 1;

FIG. 4 shows a three-dimensional schematic view of the lid body of FIG. 1;

FIG. 5 shows a plan view of a transmission mechanism and a storage compartment of FIG. 1;

FIG. 6 shows a three-dimensional schematic view of FIG. 5;

FIG. 7 is a top plan schematic view of FIG. 1;

FIG. 8 is a cross-sectional view taken along line A-A of FIG. 7;

FIG. 9 shows a three-dimensional schematic view of an elastic clamper of FIG. 1.

### DESCRIPTION OF REFERENCE SIGNS

| No. | Name |
|---|---|
| 100 | earphone charging case |
| 1 | case body |
| 11 | inwardly extending part |
| 1a | driving guide-groove |
| 11a | inclined section |
| 12a | lateral section |
| 13 | post |
| 2 | storage compartment |
| 20 | rotating part |
| 21 | mounting bracket |
| 3 | lid body |
| 30 | driving part |
| 31 | first driving block |
| 32 | second driving block |
| 3a | driving groove |
| 3b | guiding groove |
| 4 | transmission mechanism |
| 41 | driving rod |
| 411 | teeth |
| 41a | restraining groove |
| 42 | drive gear |
| 43 | first transmission gear |
| 44 | second transmission gear |
| 5 | driving arm |
| 6 | elastic clamper |
| 61 | inclined tooth |
| 62 | sliding sleeve |
| 63 | connecting part |
| 7 | spring |
| 8 | installation board |

The realization of the objects, functional features and advantages of the present disclosure will be further described with reference to the accompanying drawings in conjunction with the embodiments.

### DETAILED DESCRIPTION

The technical solutions of the embodiments of the present disclosure will be described clearly and completely below in conjunction with the drawings of the embodiments of the present disclosure. Obviously, the described embodiments are only part of the embodiments of the present disclosure, not all of them. Based on the embodiments in the present disclosure, all other embodiments obtained by a person of ordinary skill in the art without creative labor fall within the scope of protection of the present disclosure.

It should be noted that if the embodiments of the present disclosure involve directional indications (such as up, down, left, right, front, back, etc.), these directional indications are used only to explain the relative positional relationships and motion conditions of components under a specific posture (as shown in the drawings). If this specific posture changes, then the directional indications also change accordingly.

Furthermore, if the embodiments of the present disclosure involve descriptions such as “first” and “second”, these terms are used for descriptive purposes only and should not be construed as indicating or implying relative importance or implicitly indicating the number of features indicated. Therefore, features defined by “first” and “second” can include at least one of the features. Additionally, “and/or” throughout the text refers to three separate scenarios; for example, “A and/or B” includes the scenario of A, the scenario of B, or the scenario where both A and B are satisfied. Furthermore, the technical solutions of different embodiments can be combined, but this must be based on the feasibility by those skilled in the art. When there is a contradiction or it is impossible to implement the combination of technical solutions, such combinations shall be deemed non-existent and not within the scope of protection sought by the present disclosure.

With development of current TWS wireless earphones, although various types of headphones continue to emerge, access to the earphones from the earphone charging case is relatively single and generally involves flipping or sliding the lid, which influences the user experience and lacks innovative usage forms.

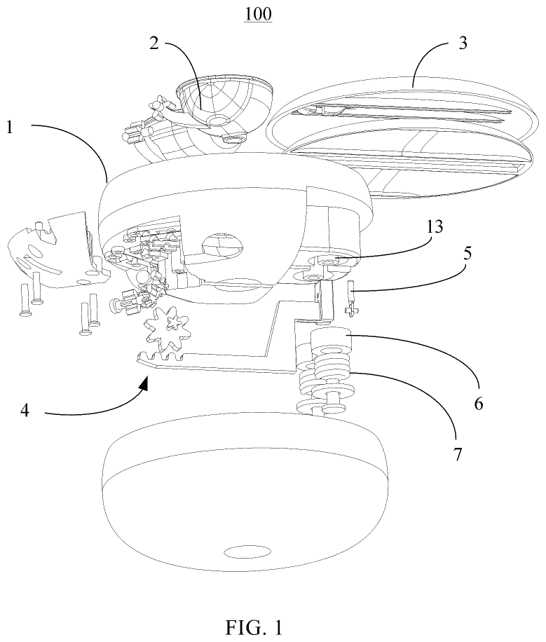

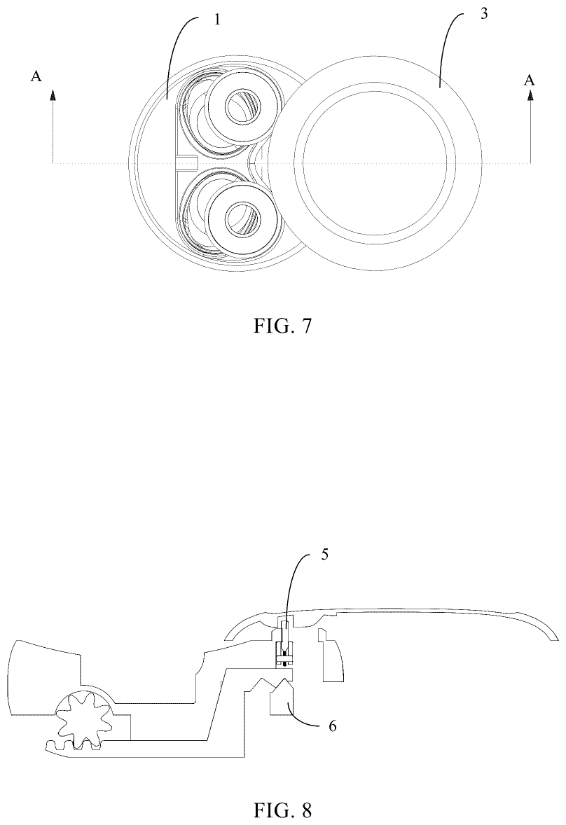

In order to solve the above problems, satisfy the user's experience, increase the sense of ceremony and experience when using the TWS earphone as well as stimulate the market demand, the present disclosure provides an earphone charging case 100, and FIGS. 1 to 9 show specific embodiments of the earphone charging case 100 provided in the present disclosure.

Referring to FIGS. 1 to 4, the earphone charging case 100 comprises a case body 1, a storage compartment 2, a lid body 3, and a transmission mechanism 4. The case body 1 is provided with an accommodating cavity that has an opening at its upper end; the storage compartment 2 is installed in the accommodating cavity in a manner capable of revolving up and down so as to have an upward exposure movement stroke in which the storage compartment swings toward the opening and a storing movement stroke in which the storage compartment goes down to move within the accommodating cavity; the lid body 3 is movably provided at an open end of the case body 1 and has an opening movement stroke for opening the opening and a closing movement stroke for closing the opening; and the transmission mechanism 4 is provided inside the case body 1 and is in transmission connection with both the storage compartment 2 and the lid body 3 so as to correspondingly convert the opening movement stroke of the lid body 3 into the exposure movement stroke of the storage compartment 2, and the closing movement stroke of the lid body 3 into the storing movement stroke of the storage compartment 2.

In the technical solution of the present disclosure, the lid body 3 may open and close the opening of the case body 1 in the movement stroke, and since the transmission mechanism 4 is in transmission connection with the storage compartment 2 and the lid body 3, the transmission mechanism 4 converts the opening movement stroke and the closing movement stroke of the lid body 3 correspondingly into the exposure movement stroke and the storing movement stroke of the storage compartment 2. The storage compartment 2 may be installed in the accommodating cavity of the case body 1 in a manner capable of revolving up and down, and when opening the lid body 3, the storage compartment 2 swings toward the opening, and while the storage compartment 2 is raised to be exposed, it is inclined at a certain angle towards the user, which gradually elevates the earphone placed inside the storage compartment 2 and presents it to the user, thereby presenting the earphone with a better sense of ceremony and increasing the user's experience so as to solve the problem that the way of taking earphones out from the existing earphone charging cases 100 is relatively monotonous and lacks innovation.

Specifically, the lid body 3 may be opened by sliding or rotating. To make it convenient for the user to operate with one hand, in the present embodiment, the lid body 3 is slidably provided at the open end of the case body 1 along a lateral direction, and the transmission mechanism 4 transforms a transverse movement of the lid body 3 into revolution of the storage compartment 2. The user only needs to hold the earphone charging case 100 with one hand and push the lid body 3 with a thumb to realize the opening movement stroke of the lid body 3, and when the case body 1 needs to be closed, the user only needs to push the lid body 3 with an index finger, or hold the earphone charging case 100 and push the lid body 3 with four fingers.

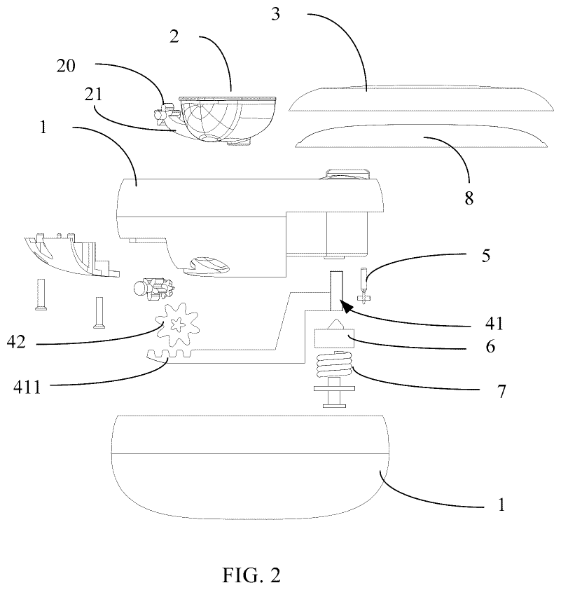

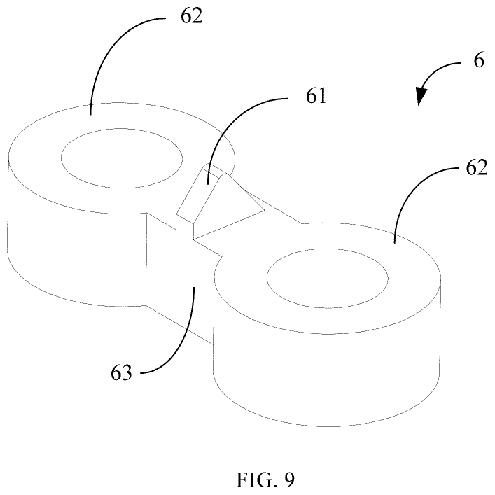

Specifically, please refer to FIGS. 2 and 8, in the present embodiment, the storage compartment 2 has a rotating part 20 provided along a longitudinal direction such that the storage compartment 2 revolves around the longitudinal direction; the transmission mechanism 4 comprises a driving rod 41 and a drive gear 42; the driving rod 41 is slidably provided along the lateral direction, one end of which is in driving connection with the lid body 3 to be driven by the lid body 3 to slide along the lateral direction when the lid body 3 slides along the lateral direction; the driving rod 41 is provided with a plurality of teeth extending along the lateral direction; the drive gear 42 is engaged with the plurality of teeth of the driving rod 41, which, in the rotating stroke of the drive gear 42, are sequentially engaged with the drive gear 42 to be driven by the driving rod 41 to rotate; and the drive gear 42 is in driving connection with the rotating part 20 of the storage compartment 2 to drive the rotating part 20 of the storage compartment 2 to rotate. In this way, the sliding of the driving rod 41 along the lateral direction is converted into the swing of the storage compartment 2 in a relatively compact structure, which transmission mode realizes conversion of the drive of the external thrust into the revolution of the storage compartment 2.

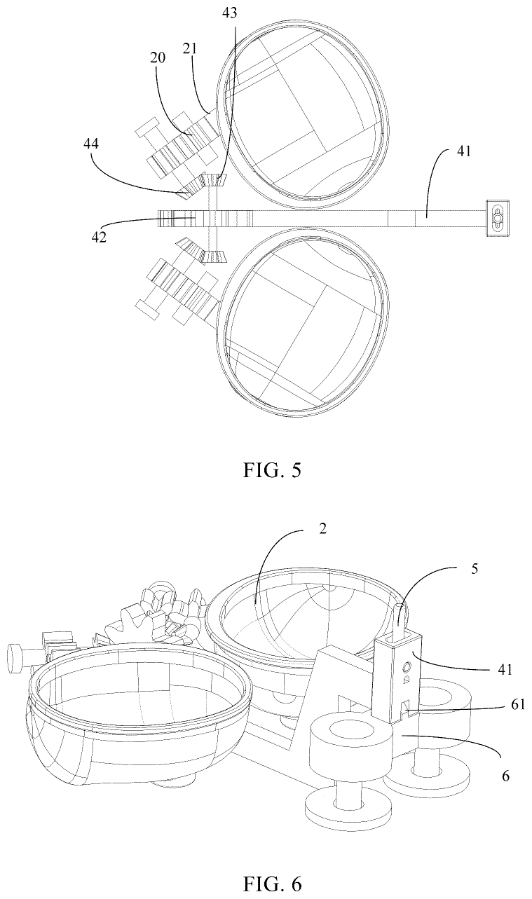

Specifically, please refer to FIG. 5, in the present embodiment, the transmission mechanism 4 further comprises a transmission gear train, which comprises a first transmission gear 43 and a second transmission gear 44. The first transmission gear 43 is provided coaxially with the drive gear 42, and while the drive gear 42 rotates, the first transmission gear 43 also rotates at the same angular velocity; and the second transmission gear 44 is engaged with the first transmission gear 43, and is connected to the rotating part 20 of the storage compartment 2. It can be understood that the second transmission gear 44 and the rotating part 20 of the storage compartment 2 may be in direct driving connection or in indirect driving connection.

Further, since wireless earphones are typically provided in pairs for convenient wearing in the user's left and right ears, please refer to FIG. 5, in the present embodiment, two storage compartments 2 are provided, and in order to enable the two storage compartments 2 to swing up and down, the driving rod 41 is provided between the two storage compartments 2. One mounting bracket 21 extends obliquely toward the driving rod 41 from a side of each of the storage compartments 2, the rotating part 20 of each of the storage compartments 2 is mounted on a corresponding mounting bracket 21, and an axis of the rotating part 20 is inclined with respect to an axis of the drive gear 42; since the mounting bracket 21 has a certain length, the storage compartment 2 can achieve a larger swing amplitude when the rotating part 20 rotates at only a smaller angle, and it is possible to achieve transmission at the same time of considering the shape of the case body 1 and the compactness of the internal space arrangement, and the first transmission gear 43 and the second transmission gear 44 may be provided as bevel gears to transform rotation of the drive gear 42 into rotation of the rotating part 20. It can be understood that, in order to transmit the torque from the second transmission gear 44 to the rotating part 20, the transmission mechanism 4 further comprises a third transmission gear, which is coaxially provided with the second transmission gear 44. The rotating part 20 may be configured as a fourth transmission gear, and the storage compartment 2 is rotationally mounted on the case body 1 via the shaft of the fourth transmission gear. The third transmission gear is engaged with the first transmission gear 43 to cause the fourth transmission gear to rotate, such that the storage compartment 2 swings around the shaft of the fourth transmission gear.

Specifically, please refer to FIG. 4, in the present embodiment, the lid body 3 is provided with a driving part 30; a driving arm 5, which extends up and down and is slidably provided in the lateral direction, is further provided between the driving rod 41 and the lid body 3; a lower end of the driving arm 5 is connected to one end of the driving rod 41, and an upper end of the driving arm 5 extends to the lid body 3 to be driven by the driving part 30 and to bring the driving rod 41 to move along the lateral direction together. In this way, the lid body 3 and the driving rod 41 arranged at intervals in the up-down direction may be in transmission connection by the driving arm 5 extending up and down.

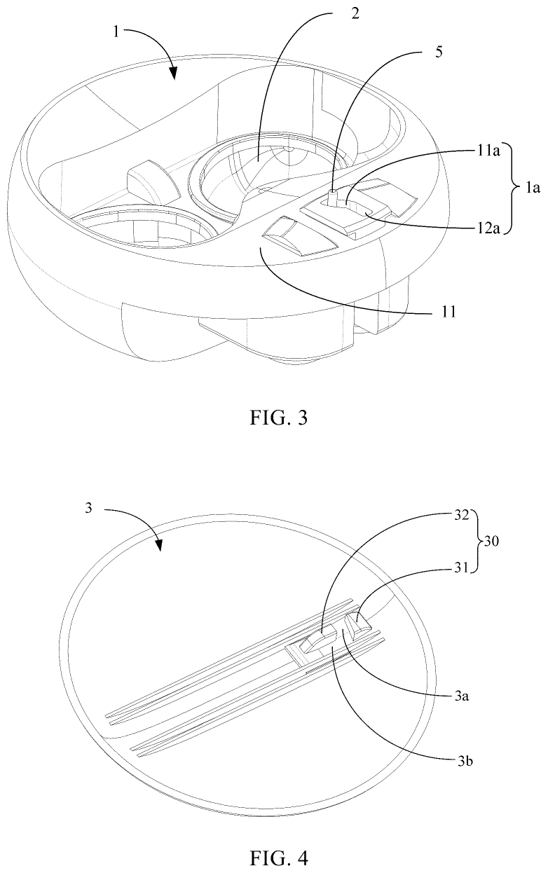

Specifically, since the opening of the lid body 3 may be opened and closed when the lid body 3 slides along the lateral direction, it can be understood that when the lid of the lid body 3 is opened, it is necessary to provide a driving part 30 which drives the driving arm 5 to move in the direction for opening the lid; similarly, when the lid body 3 is closed, it is necessary to provide a driving part 30 which drives the driving arm 5 to move in the direction for closing the lid. Please refer to FIGS. 3 to 4, specifically, in the present embodiment, the driving part 30 comprises a first driving block 31 and a second driving block 32 that are provided on the lid body 3 and are provided oppositely to each other along the lateral direction, the first driving block 31 is located behind the second driving block 32 in a direction of the lid body 3 for slidably opening a lid, and protrudes from the second driving block 32 in the longitudinal direction, and a driving groove 3a is formed between the first driving block 31 and the second driving block 32; the accommodating cavity is provided with an inwardly extending part 11 above the driving rod 41, and the inwardly extending part 11 is provided with a driving guide-slot 1a, which has an inclined section 11a that is inclined with respect to the lateral direction and a lateral section 12a that extends along the lateral direction; a lower end of the driving arm 5 is floatingly connected to the driving rod 41 in the longitudinal direction, and an upper end of the driving arm 5 extends out from the driving guide-slot 1a; wherein, during the opening movement stroke of the lid body 3, the upper end of the driving arm 5 abuts against the first driving block 31 to be driven by the first driving block 31 to move, such that the upper end of the driving arm 5 floats longitudinally into the driving groove 3a; during the closing movement stroke of the lid body 3, the upper end of the driving arm 5 abuts against the second driving block 32 to be driven by the second driving block 32 to move, and the second driving block 32 drives the driving arm 5 to move along the inclined section 11a of the driving guide-slot 1a, and drives it to slide longitudinally out of the driving groove 3a.

Specifically, the form of driving the upper end of the driving arm 5 to move longitudinally may be by sliding mode or by rotating connection. Please refer to FIGS. 6 and 8, in a specific embodiment, the lower end of the driving arm 5 is rotationally installed on the driving rod 41 along a transverse axis, such that the lower end of the driving arm 5 is floatingly connected to the driving rod 41 in the longitudinal direction, leading to a simple and compact structure.

Specifically, please refer to FIG. 4, in the present embodiment, a side of the first driving block 31 facing the second driving block 32 is inclined to guide the upper end of the driving arm 5 into the driving groove 3a. When the upper end of the driving arm 5 abuts against the inclined surface of the first driving block 31, the force applied by the inclined surface to the upper end of the driving arm 5 may be decomposed into a force in the lid opening direction, that is, a force in the lateral section, and a force in the longitudinal direction, so that the upper end of the driving arm 5 may slide into the driving groove 3a along the inclined surface.

Further, it can be understood that when opening the lid body 3, it is necessary to stagger a certain distance from the case body 1 before the storage compartment 2 has room to swing towards the opening of the case body 1, and thus the specific driving mode of the driving part 30 needs to consider how to cooperate with the driving arm 5 in the opening movement stroke and closing movement stroke of the lid so as to drive the driving rod 41 when it needs to be driven. Please refer to FIG. 4, the lid body 3 is provided with a guiding groove 3b extending along the lateral direction, and in a direction of the opening movement stroke of the lid body 3, the guiding groove 3b is located at a rear end of the driving groove 3a, and one end of the guiding groove 3b extends to the driving groove 3a.

Further, since the lid body 3 can freely slide along the lateral direction, especially when the upper end of the driving arm 5 cooperates with the guiding groove 3b to slide, at this point, it is not necessary for the driving rod 41 to continue moving along the lateral direction so as to avoid the storage compartment 2 from swinging up and down at any time, and thus it is possible for the driving rod 41 to be limited after the storage compartment 2 swings to a proper angle. Please refer to FIG. 8, in the present embodiment, the driving rod 41 is provided with an elastic clamper 6 on one side thereof; the driving rod 41, on one side thereof corresponding to the elastic clamper 6, is provided with two restraining grooves 41a arranged at intervals along the lateral direction so that the elastic clamper 6 may be clamped in one of the two restraining grooves 41a in the opening movement stroke, that is, when the upper end of the driving arm 5 leaves the driving groove 3a, the elastic clamper 6 cooperates with one of the restraining grooves 41a. It can be understood that in the closing movement stroke, the elastic clamper 6 may be clamped in the other restraining groove 41a, that is, when the upper end of the driving arm 5 is driven into the driving groove 3a, the elastic clamper 6 cooperates with the other restraining groove 41a.

Specifically, to make the user obtain a better mechanical feel when opening and closing the lid, please refer to FIGS. 8 to 9, in the present embodiment, a free end of the elastic clamper 6 is formed with an inclined tooth 61, which comprises two inclined guiding surfaces arranged at an angle to each other; each restraining groove 41a is provided with two opposite sidewalls, which are arranged at an angle to each other and respectively abut against the two inclined guiding surfaces such that when the driving rod 41 slides, the inclined tooth 61 may slide along one of the two sidewalls. When the inclined tooth 61 moves to the highest point along one of the two sidewalls, the inclined tooth 61 abuts against one sidewall of the restraining groove 41a, and the sidewall is inclined such that the inclined tooth 61 can rapidly slide along the sidewall under the action of the elastic force, and is clamped in the restraining groove 41a.

Specifically, please refer to FIG. 9, in the present embodiment, the inwardly extending part 11 is formed with two posts 13 spaced in the longitudinal direction, between which the driving rod 41 is provided; the elastic clamper 6 comprises two sliding sleeves 62 that are respectively sleeved with the two posts 13, and a connecting part 63 for connecting the two sliding sleeves 62, and the inclined tooth 61 is formed on the connecting part 63. Since the inclined tooth 61 is provided between the two sliding sleeves 62, the inclined tooth 61 is more stable and is stressed more uniformly when the inclined tooth 61 moves in a floating manner. To enable the elastic clamper 6 to float, each of the two sliding sleeves 62 and the inwardly extending part 11 are provided with a spring 7 therebetween, which is connected to a corresponding sliding sleeve 62 at one end and is connected to the inwardly extending part 11 at the other end.

Further, in order to enable the lid body 3 to have a relatively complete appearance so as to avoid that external dust falls into the driving groove 3a and the guiding groove 3b and thus influences the normal use of the lid body 3, please refer to FIGS. 1 to 2, in the present embodiment, the earphone charging case 100 further comprises an installation board 8 that is slidably installed at the open end of the case body 1, and the lid body covers an upper end of the installation board 8, which creates a relatively sealed space between the installation board 8 and the lid body. In order to facilitate the driving arm 5 to extend into the lid body 3 and to open and close the lid without interfering with the installation board 8, the installation board 8 is formed with a sliding groove extending in the lateral direction, which is provided corresponding to the driving groove 3a and an escape groove, that is, the upper end of the driving arm 5 can slide along the sliding groove.

The foregoing are merely preferred embodiments of the present disclosure and are not to be construed as limiting the scope of the present disclosure. Any equivalent structural transformation made by using the contents of the specification and the drawings of the present disclosure under the inventive concept of the present disclosure, or directly/indirectly applied to other related technical fields, are included in the patent protection scope of the present disclosure.

1. An earphone charging case, comprising:
a case body provided with an accommodating cavity that has an opening at its upper end;
a storage compartment that is installed in the accommodating cavity in a manner configured to revolve up and down so as to have an upward exposure movement stroke in which the storage compartment swings toward the opening and a storing movement stroke in which the storage compartment goes down to move within the accommodating cavity;
a lid body that is movably provided at an open end of the case body and has an opening movement stroke for opening the opening and a closing movement stroke for closing the opening; and
a transmission mechanism that is provided inside the case body and is in a transmission connection with both the storage compartment and the lid body so as to correspondingly convert the opening movement stroke of the lid body into the exposure movement stroke of the storage compartment, and the closing movement stroke of the lid body into the storing movement stroke of the storage compartment.

2. The earphone charging case according to claim 1, wherein the lid body is slidably provided at the open end of the case body along a lateral direction; and
the transmission mechanism transforms a transverse movement of the lid body into a revolution of the storage compartment.

3. The earphone charging case according to claim 2, wherein the storage compartment has a rotating part provided along a longitudinal direction such that the storage compartment revolves around the longitudinal direction;
the transmission mechanism comprises:
a driving rod that is slidably provided along the lateral direction, one end of which is in a driving connection with the lid body to be driven by the lid body to slide along the lateral direction, the driving rod being provided with a plurality of teeth extending along the lateral direction; and
a drive gear that is engaged with the plurality of teeth of the driving rod to be driven by the driving rod to rotate, the drive gear being in a driving connection with the rotating part of the storage compartment to drive the rotating part of the storage compartment to rotate.

4. The earphone charging case according to claim 3, wherein the transmission mechanism further comprises a transmission gear train, which comprises:
a first transmission gear that is provided coaxially with the drive gear; and
a second transmission gear that is connected to the rotating part of the storage compartment, and is engaged with the first transmission gear.

5. The earphone charging case according to claim 4, wherein two storage compartments are provided;
the driving rod is provided between the two storage compartments, one mounting bracket extends obliquely toward the driving rod from a side of each of the storage compartments, the rotating part of each of the storage compartments is mounted on a corresponding mounting bracket, and an axis of the rotating part is inclined with respect to an axis of the drive gear; and
the first transmission gear and the second transmission gear are provided as bevel gears to transform rotation of the drive gear into rotation of the rotating part.

6. The earphone charging case according to claim 4, wherein the lid body is provided with a driving part; and
a driving arm, which extends up and down and is slidably provided in the lateral direction, is further provided between the driving rod and the lid body, a lower end of the driving arm is connected to one end of the driving rod, and an upper end of the driving arm extends to the lid body to be driven by the driving part and to bring the driving rod to move along the lateral direction together.

7. The earphone charging case according to claim 6, wherein the driving part comprises a first driving block and a second driving block that are provided on the lid body and are provided oppositely to each other along the lateral direction, the first driving block is located behind the second driving block in a direction of the lid body for slidably opening the lid body, the first driving block protrudes from the second driving block in the longitudinal direction, and a driving groove is formed between the first driving block and the second driving block where the two driving blocks face each other;
the accommodating cavity is provided with an inwardly extending part above the driving rod, and the inwardly extending part is provided with a driving guide-slot, which has an inclined section that is inclined with respect to the lateral direction and a lateral section that extends along the lateral direction;
a lower end of the driving arm is floatingly connected to the driving rod in the longitudinal direction, and an upper end of the driving arm extends out from the driving guide-slot; and
wherein, during the opening movement stroke of the lid body, the upper end of the driving arm is driven by the first driving block, such that the upper end of the driving arm floats longitudinally into the driving groove; during the closing movement stroke of the lid body, the driving arm is driven by the inclined section of the driving guide-slot to slide longitudinally out of the driving groove.

8. The earphone charging case according to claim 7, wherein the lower end of the driving arm is rotationally installed on the driving rod along a transverse axis, such that the lower end of the driving arm is floatingly connected to the driving rod in the longitudinal direction.

9. The earphone charging case according to claim 7, wherein one side of the first driving block facing the second driving block is inclined to guide the upper end of the driving arm into the driving groove.

10. The earphone charging case according to claim 7, wherein the lid body is provided with a guiding groove extending along the lateral direction, and in a direction of the opening movement stroke of the lid body, the guiding groove is located at a rear end of the driving groove, and one end of the guiding groove extends to the driving groove.

11. The earphone charging case according to claim 7, wherein the driving rod is provided with an elastic clamper on one side thereof; and
the driving rod, on one side thereof corresponding to the elastic clamper, is provided with two restraining grooves arranged at intervals along the lateral direction so that the elastic clamper clamps with one of the two restraining grooves in the opening movement stroke, and the elastic clamper clamps with the other restraining groove in the closing movement stroke.

12. The earphone charging case according to claim 11, wherein a free end of the elastic clamper is formed with an inclined tooth, which comprises two inclined guiding surfaces arranged at an angle to each other; and
each restraining groove is provided with two opposite sidewalls, which are arranged at an angle to each other and respectively abut against the two inclined guiding surfaces so that when the driving rod slides, the inclined tooth slides along one of the two sidewalls.

13. The earphone charging case according to claim 12, wherein the inwardly extending part is formed with two posts spaced in the longitudinal direction, with the driving rod is provided therebetween;
the elastic clamper comprises two sliding sleeves that are respectively sleeved with the two posts, and a connecting part for connecting the two sliding sleeves, with the inclined tooth being formed on the connecting part; and
each of the two sliding sleeves and the inwardly extending part are provided with a spring therebetween, which is connected to a corresponding sliding sleeve at one end and is connected to the inwardly extending part at the other end.

14. The earphone charging case according to claim 10, wherein the earphone charging case further comprises an installation board that is slidably installed at the open end of the case body, and the lid body covers an upper end of the installation board; and
the installation board is formed with a sliding groove extending in the lateral direction, which is provided corresponding to the driving groove and an escape groove.
